(19) United States
(12) Patent Application Publication
(10) Pub. No.: US 2010/0017211 A1
(43) Pub. Date: Jan. 21, 2010

(54) Method for the construction of a cross-linked system

(76) Inventor: Alexander Kramer, Pasadena, CA (US)

Correspondence Address: TOPE-MCKAY & ASSOCIATES, 23852 PACIFIC COAST HIGHWAY #311, MALIBU, CA, 90265, US

(21) Appl. No.: 11/629,161

(22) PCT Filed: Jun. 9, 2005
(86) PCT No.: PCT/EP05/06216

§ 371 Date: Jul. 7, 2009

(30) Foreign Application Priority Data
Jun. 9, 2004 (DE) 10 2004 028 166.1

(51) Int. Cl. G10L 21/00; G06F 17/27; G06T 11/20

(52) U.S. Cl. 704/270; 704/9; 345/440; 704/E21.001

(57) ABSTRACT

Disclosed is a method for constructing a cross-linked system whose topology of components creates a network, especially a method for creating predetermined functional units, such as cell types and tissues as well as biological and/or physical components that are based thereupon, by developing the cross-linking of the system in a self-organizing manner. The inventive method is characterized by the following steps: a) the network is represented by graph; b) edges of the said graph are provided with markings which are formed such that the graph can be unambiguously assigned to a minimal automaton; c) the automaton is described by a formal grammar representing a system of equations whose solution are defined in text form. The approach to obtain the solutions of the system of equations describes a way to construct the system, while transducers insert the components into the network in order to entirely construct the system.

### TECHNICAL ARGUMENT

The construction and/or the reconstruction (e.g. repair) of a system by iterative assembling steps is considered, where each iterative step comprises functional construction stage of one part of a system.

For the construction of a system, a cross-linkage of a set of system components is chosen to generate a functional building step, by using given forces of nature and physical characteristics such as relations among the systems components, that are used in a particular construction stage.

Each construction step, which involves either adding function/quality to the system and/or change the cross linkage of system components, is used as a component in the successive assembling stage.

The procedure of cross-linking components to become functional construction steps and assembling these functional construction steps is iterated to create and/or add function and quality to the system, ie. develop the system.

To date the realization of development of a system is utilizing the man-made mind, sense and intelligence of e.g. an architect.

However, the application of the procedure in conformity with the invention automates the development of a system by coding the development as the cross-linkage of a set of algebraic equations, such that solving iteratively the system of equation produces automatically the development of the real world system.

Since both, the development of the system as well as the solution of the corresponding equation system is base on an mathematical algebra, it is possible to plan the automated (self-organized) development of systems and design an arbitrary automated development of any functional component.

Moreover, the production/construction of functional components is a technical task, which is accomplished easier by automated development which increases the overall cost-efficiency of a construction process.

The practical application of the procedure in conformity with the invention accomplishes a technical task and is therefore of technical character.

### DESCRIPTION

The rendered technical problem is exemplary circumstantiated considering the development of an embryo. An embryo develops from a fertilized egg cell (the Oocyte). In a the first phase of biological development a small number of cells (the stem cell) originate from the egg-cell by cells division (cleavage), which give rise to a cluster of cells by further cleavage. A phase of cell motion can follow, in which individual cells move through the cell aggregate to a new position. Once a cell found its new neighbors a cleavage phase follows, which is again succeeded by a phase of cell motion (ie. cell determination, cell differentiation and cell proliferation). These phases alternate until all necessary cells are produced and have found their correct neighbors. This process structures the embryo completely. Each cell knows its fate (nerve, muscle) and has the correct relative position (for organs to be produced thereupon). Cells are thus correctly positioned and determined. This procedure is denoted as development by means of self-organization.

The questions of interest are now: How to realize resp. apply technically a self-organized development? How dose such a self-organized development work and how derives a possible construction procedures therefrom?

Perhaps one desires to design a different embryo with different cell types and positions. Such a self-organized development is coded on the DNA. The DNA is sequence of chemical construction units assigned a letter (chemical letters A, T, C, G), the nucleotides (Adenin, Thymin Cytoin and Guanin) abbreviated by the initial letters (and a sequence is e.g. TACG-TAACCTGT). This succession of letters may be interpreted a “text” of a language (made of words resp. a set of “letter sequences”), which simplifying will be denoted in the following as a “text”.

In demand is a procedure, that decodes a text (eg. the DNA), that holds the blueprint of the development, into a “self-organizing development”, which produces an organism (or a system) from cells (or components).

We abstract cells to become generalized building blocks (components), which are to be assembled in the right order to constitute the system. Such building blocks are found e.g. within an electrical network, that is assembled due to a wiring diagram.

The disclosed procedure for self-organized development of such systems distinguish oneself by the fact that a construction step (i.e. the instruction to correctly assemble building block) arises from its proceeding construction step.

This is achieved by formulating a construction step as an algebraic equation, which can be solved. All construction together steps form an algebraic system of equations. In mathematics, algebraic equation systems are solved by successive elimination of unknown variables. A solution for one first unknown variable is inserted into another equation which can be solved thereupon for the next unknown variable. This automatism iterates until all equations are solved. Each approach of solving one equation for one unknown variable represents one construction step and thereby consequently constructs the embryo or the electric circuit, which is represented by its abstract wiring diagram. Here the utilized wiring diagram is replaced by an interlaced or nested system of equation.

The above mentioned equation system is one, which has a “text” as a solution, and not “numbers” as it is usually the case in algebraic equation system. This “text equation system” represents a set of grammatical rules, which permits only a text as syntactically correct, a so named regular expression.

The enigma or trick of the disclosed procedure is twofold.

Firstly, the algebraic character of regular expressions are used, which is to be a solution of a text equation (grammar) system.
Secondly, the procedure of solving the text equation system (i.e. a formal grammar) is used to ascertain corresponding regular expression, and can therefore be used as the construction procedure (development) of the system.

More precise: Regular Expression (abrev. regexp) stem from the theory of formal languages, which are the foundation of all computer languages. The regexp is a parenthesis expression as e.g. “(ab U c)”, which connects two qualities. On the one hand it has algebraic features, on the other hand it is a “text”. The algebraic feature is, that e.g. (ab) represents a geometric line element and (ab U c) can be interpreted as a geometric triangle. Comparatively, as an algebraic equation (ax+by=1) is referred to the geometric object of a line, by taking advantage of the text quality.

A formal language grammar is made of rules for substitutions (i.e. the productions), which determine how different texts are to be constructed (e.g. <sentence>=<subject><predicate><object>) in order to be recognized as a sentence of the language. The rules of substitution are named “productions”, where each production is an equation as in the above mentioned example.

Decomposing the regexp in productions produces simultaneously the corresponding geometric structure (e.g. lines which are assembled to a triangle). If an electric circuit made of three resistors is to be assembled, which form a triangle, one substitutes in (ab U c) for a, b, and c simply the values for the electric resistors.

In electronics particular “measures” are assigned to building blocks to characterize them. A resistor is e.g. characterized with the measure “Ohm”. If one chooses a, b, and c to represent electrical measure values, one gets an electronic circuit. If mechanical measures are used, one develops a mechanical structure (like e.g. a scaffolding or a building). If instead measures are used that characterize building blocks of molecular biology, one develops biological structure like e.g. an embryo.

Therefore one produces a development made from text-building-blocks, which are connected by equation systems. Here not a mathematical formula is the subject to be protected, instead it is the procedure to generate a self-propagating (self-organizing) development. This is one essential quality of all living system of nature.

The disclosed invention allows to construct and develop arbitrary structures depending on the measures used to characterize building blocks, by using a coded sequence of construction steps.

The disclosed procedure obtains particular importance, if it becomes common currency, how such a the production method is realized (picked out and solved) on the DNA. It is know, that the biological development can be represented (described) as a grammar on the DNA sequence. Instead, it is unknown to date, how to translate the DNA sequence into a molecular-biological measure, which assigns a sequence (e.g. TACGTAACCTGT . . . ) to the control region of a gene. These so-called cis-regulatory regions can realize the function of the above (formal language grammar) productions. These regions control the gene activity for specific and defined conditions. The gene activity (reading the control sequence) in turn is equivalent to solving one equation, if the corresponding variables are substituted (ie. the necessary conditions exist, that are produced by solving a preceding (cis-regulatory regions) equation).

Two publications from (Frank Vahid et al in SpecCharts: A VHDL Front-End for Embedded Systems) and (SpecSyn: An Environment Supporting the Specify-Explore-Refine Paradigm for Hardware/Software System Design Daniel D. Gajski, Fellow, IEEE, Frank Vahid, Member, IEEE, Sanjiv Narayan, and Jie Gong) describe how to simulate in different programming languages (especially in the well known VHDL and SpecChart) the function of a concrete (specific) system (eg. an phone answering machine) and describe it by the (successive temporal) order of functional events. At this, the authors take into consideration that systems can be comprised of hardware and software. In case a system contains as well software components, the authors assume the a microprocessor controls the system behavior. The system is given in a programming language by a programming text, which can be executed on a digital computer. The order of programming events can also be given in a graphic flow diagram, which represents an equivalent to the programming text.

The system-properties outlined in the here disclosed procedure is not a “programming text” (as in the above articles), instead it is an expressions (i.e. a regular expression) which is graphically represented as a geometric object combined with an algebraic solution. In contrast to a program, that is comprised of a organized (structured) text of computer (processor) executable instructions, the (regular) expression is a “formula-text”, as it is well known from algebra (e.g. mathematical equation). One important distinction is that the regular expression is interpreted as a solution of an equation system, that represents the manufacturing procedure (i.e. the development of components) of the system. Here the biological origin of the approach becomes discernible.

In case of the description by programming languages (eg. VHDL and SpecChart), the process of manufacturing needs to be programmed in an additional programming text, since a VHDL/SpecChart programming text dose not have a solution. Further, the regular expressions equivalent geometric object resp. the equivalent graph can specify the topological assignment of system components (eg. the network of a circuit diagram), whereas the flow-diagram of a VHDL/SpecChart program reports the order of functional (temporal) events of the system.

Both, the articles and the disclosed procedure deal with representations of systems in the form of text and assigned graphs (in context of formal-resp. computer languages).

However they are entirely different, by the fact that the articles describe how to produce a computer program for a system, whereas regular expressions used in conformity with the disclosed invention represent a blueprint or the system structure that arise as a solution and the construction of this system obeys a grammar of these regular expressions.

The geometric graph of the system obeys therefore an equation system. This equation system is represented by a grammar, which is solved by the “text of regular expressions”. This solution correlates the procedure of construction, i.e. how the system is to be assembled and thus it is the development of the (self-organized) system.

Presently systems being patent subject matter of such a procedure are composed of components, which are connected with each other. This is immediately obvious with electronic circuits. The properties and the behavior of such systems are discussed in system theory [CD91b] (Frank M. Callier and Charles A. Desoer. Linear System Theory. Springer Verlag, 1991.), [CD91a] (F. M. Callier and C. A. Desoer. Linear System Theory. Springer Verlag, 1991.), [Krä99] (A. Kraemer. Struktur und dynamik eines komplexen systems charakterisiert mittels der multiresolution-technik der signalanalyse am beispiel von Relaxationsoszillationen. Master's thesis, Biochemisches Institut Im Fachbereich Medizin der Universitaet zu Kiel, January 1999. Diplom in Physik.), [Wil96] (J. R. Wilson. Linear system theory. Prentice Hall, Upper Saddle River, N.J., 1996.).

In nature such systems are amenable to physical laws, which are represented by the discrete components. Real systems of nature again are amenable to the laws of thermodynamics [OPK71] (G. Oster, A. Perelson, and A. Katchalsky. Network thermodynamics. Nature, 234, 1971.), [OD71] (G. F. Oster and C. A. Desoer. Tellegen's theorem and thermodynamic inequalities. Journal of Theoretical Biology, 32:219-241, 1971.), [Ons31] (L. Onsager. Reciprocal relation in irreversible process. Phys. Rev., 32:405-426, 1931.), [Pri47] (Ily Prigogine. Etude Thermodynamiqe des Processus Irreversibeles. Liege, 1947.), [Pea93] (J. E. Pearson. Complex patterns in a simple system. Science, 261:189-92, 9. July 1993.).

Such a real system of nature can be decomposed into its components (building blocks), into the structure of the cross-linkage (framework or the systems topology, connectivity) and into the dynamics, which specifies the system-states in or at the components. This is valid for all systems of alive and inanimate nature. For the purpose of documentation of systems (eg. electronic wiring diagram) components are being replaced with “icons” (like f.e. a symbol for a resistor), which characterize the building blocks. Different possibilities to represent the system cross-linkage are discussed in the literature [GD90] (A. Goldbeter and G. Dupont. Allosteric regulation, cooperativity, and biochemical oscillations. Biophysical Chemistry, 37:341-353, 1990.), [GL72] (A. Goldbeter and R. Lefever. Dissipative structures for an allosteric model. Application to glycolytic oscillations. Biophysical Journal, 12:1302-1315, 1972.), [GDLM88] (A. Goldbeter, O. Decroly, Y. X. Li, and F. Moran. Finding complex oscillatory phenomena in biochemical systems; an empirical approach. Biophysical Chemistry, 29:211-217, 1988.).

Further the development of computers has resulted also to a development of computer languages, which are used to program computers [AU77] (A. Aho and J. D. Ullman. Addison Wesley, 1977.). As with a natural language also the formal computer languages (like Fortran, Algol, C, C++ etc) are amenable to rules being denoted as “grammar” ([AU77] Parser). The grammar structures a text, such that a sequence of letters of an alphabet becomes an interpretable sentence with conceivable content. One to the grammar corresponding analog for images or sequences images is still an outstanding demand. Nevertheless there are automaton (so-called recognizer and transducer) known, which assign a graph to a grammar (i.e. an image or a framework) [HD94] (Jhon E. Hopcroft and Ullman Jeffrey D. Einfuehrung in die Automatentheorie, formale Sprachen und Komplexitaetstheorie. Addison Wesley, 1994.), [Ber79] (J. Berstel. Transductions and Context-Free Languages. Teubner, Stuttgart, 1979.). Also computer algorithms have been developed to translate a graph into a language forth and back [MMTV] (O. Matz, A. Miller, A. and Potthoff, W. Thomas, and E. Valkema). The scientific discipline of informatics [HD94] deals with such problems. With the development of graphical tools (eg. computer programs) used to display images on a computer monitor also the so-called branch of “computational geometry” evolved. Here a geometric object is represented as a framework of with each other cross-linked components (lines, triangles, etc.) [SML98] (W. Schroeder, K. Martin, and B. Lorensen. The visualization toolkit vtk. ISBN: 0-13-954694-4. Prentice Hall PTR, 1998.), [Xie00] (Changsong Xie. Syntax-oriented Coding A Data Compression Scheme for Syntactically Structured Sources. PhD thesis, UNVERSITAT DER BUNDESWEHR MUNCHEN Fakultat fr Elektrotechnische, 2000.), [ET75]: (Hartmut Ehrig and Karl Wilhelm Tischer; Graph grammars and application to specialization and evolution in biology; Journal of Computer and System Science 11:212-236, 1975).

At the present time, these well known procedures from the literature have disadvantages. These use auxiliary means to capture the structure of systems, as images (eg. as a wiring diagram). Images are manually edited with software programs for image manipulation. These methods are time consuming (depending on the number of components and their cross-linkages). In addition they permit the static image representation of one system, but no dynamic representation of the image construction, resp. the set of rules according to which the image is to be created, unless an image sequence (video sequence) is provided.

An assignment of the disclosed invention is to give a procedure of the capability mentioned at the beginning, which is to construct the geometric structure and/or cross-linkage of systems (image) skeleton (framework resp. topology) in a simple manner.

By using the text-form in conformity with the invention, known operations for text editing and text processing can be easily applied to system construction (as eg. searching, replacing, copying, reproducing, inserting of partial or sub-structures as well as their deletions). Thus, besides the self-organized (automated) construction of a system, also the self-organized repair is possible as soon as cross-linked compartments fail.

The task is solved by the procedure described in the claim 1.

The definitions of notions used in the claims are given in the following.

Automaton:

A (finite) automaton of a language, that describes resp. checks, if a text obeys (ie. is consistent with) the syntax (of a grammar) of the language, is mathematically described as a set A:

A={X,Q,q,Qe,δ}

where
X: is an alphabet ie. a set of letter-symbols.
Q: a (finite) set of states, which the automaton accepts and can switch into.
q: a subset of Q, which is a set of states in which the automaton is allowed be at the beginning of the consistency checks (start states).
Qe: an equivalent subset of Q, the acceptable set of end states which the automaton is allowed to switch into after processing (reading) the text.
δ is a transition function δ: Q×X→Q, giving how the automaton can switch from a given present state into a different future state of the set Q by processing a learned symbol.

Letter-Sequence:

The letter-sign-sequence (symbol sequence) defines a language L of the set of all texts u which are recognized by the automaton ie. as the automaton reads the text by means of the transition function it changed from a start state q into an end state Qe.

L={uεX*|q·uεQe}

where u is a symbol sequence (word) of the set X* of all symbol-sequences. If u as being processed (read), changes from a start state into an end state, it is consequently a word of the language L ie. the word u is recognized by the automaton.

Graph:

A graph G(V, E) is set-theoretical object ie. one set of elements V (points, knots also known as vertices) and a set E of pairs of so-called edges, which is given a an assignment B (ie. a function) of two points (vertices) to each other This (reciprocal) assignment of two points to each other is interpreted as a geometric line segment (also known as branch or edge of the graph), such that the graph is a geometric point set, where points are connected by line segments (as eg. the four corner vertices of a cube). If the points (vertices) are connected by oriented line segments, the graph is so-called an directed graph (as is can be the case for the (minimal) automaton)

Transition Function:

If on the one hand, each state Q is unambiguously assigned to a point (vertex), and on the other hand the automatons transition function δ is assigned to the edges E, consequently the automatons geometric representation as graph follows, where every edge might be provided with the processed symbol X out of the transition function δ as markings.

Minimal Automaton:

The number of states Q is for the automata A not specified, such that a language L can be represented as well by a different (altered) set Q (f.e. by enhancing or reducing the set Q for states which are never reached in the language L). If the set of states Q is reduced as far as possible, an unambiguous minimal automaton arises which represents the language L. Computer-algorithms for this reduction procedure are available (AMORE [MMTV]).

Transducer:

The automaton resp. the graph remains unaltered if the same language L is represented with a different alphabet (letter symbols) and merely the symbols assigned to the edges of the graph are replaced. If the edges of the graph are assigned at the same time with the symbols of both language-realizations (alphabets), a replacing automaton (transducer) arises, which replaces (ie. transduces) one word out of an initial language-representation (alphabet) into a word of the other (target language).

Providing Edge with Letters:

If the letter-characters of the applied alphabet are substituted by symbols (which characterize electric building blocks), the graph of the automaton becomes eg. wiring diagram of an electronic circuit.

Text as Solution of an Equation.:

Besides of the geometric representation of the language L there exists an algebraic representation, comparable to a line placed in a coordinate system, which can be drawn geometrically on graph paper, but may be also written algebraically as a·x+b·y=1. The algebraic representation of the language L is based on two alphabets, firstly the names of variables V (corresponds to x, y in the equation of a line) and secondly the name of the coefficients (fixed values) of X (corresponds to a, b in the equation). These two alphabets are linked by a function P to become a grammar G

G={V,X,P}

where V is denoted as the set of non-terminal symbols and X as the set of terminal symbols. The function P⊂V×(V∪X*) is denoted as a production-rule (short production). The production-rules P are algebraic equations

G={V,X,P}

of an in general finite equation system (the language grammar) between the unknown word-(text-) variables with words (i.e. text) as coefficients. The solution of such an equation system is a symbol sequence (resp. a text).

Production-rules are a defining part of a grammar. The productions are given in the following form: An arbitrary non-terminal symbol V will be replaced (resp.→) by some finite sequence of terminal and nonterminal symbols. Or simply α→β, where α and β can be arbitrary grammar symbols.

There exist also general productions. Productions can be represented by rules, or the action of such rules on existing productions that can alter these productions. If rules are being used to generate productions or are applied on to productions to alter or modify them, the defined grammar is altered as well. The context free grammar is changed into “context sensitive” grammar, by restricting the productions such that β must have certain qualities, which depend on the qualities of α, eg. β must be as long as α. The name “context sensitive” stems from the normalized form of a grammar, where every production is of the form α₁Aα₂→α₁βα2 where β≠ε (with ε:=empty set).

Productions of the later form have almost the same appearance like context free productions: They permit instead the substitution of a variable A with a character-chain β only in the “context” α₁-α₂. Besides the length of the character sequence there might be also defined conditions and attributes on the above restrictions (which is a rule system to generate productions, which comprises the set of construction laws, which are realized by the building-blocks).

Here (such) a new class of production is introduced to enhance the construction procedure by the so defined grammar (since the productions are the inherent grammatical kernel, which defines the constructed system and therefore holds all necessary information, which is either pre-coded and/or derived from rules/laws which these productions have to obey, like f.e. the Kirchhoff Laws of electronic circuits, otherwise the system is not functional).

This enhancement is necessary to consider the physical qualities (function) of constructed objects. The prescript to construct changes (ie. the differential of the grammar) depending on the physical qualities of the objects to be constructed (eg. molecules or building-blocks), which are represented with (text) character-sequences. Since the building-blocks have a defined set of qualities, which restrict the possible interaction laws to obey, also defined set of possible productions which give rise to a grammar that defines in turn the possible structure of systems (ie. the constructed quality).

The difference to existing production is the characterization of the arrow symbol: “→” between α and β. The arrow symbol is a prescript to substitute character-sequences and/or symbols. This prescript is enhanced by the essential feature to determine physical qualities on the one hand and to act conditionally upon these physical qualities on the other hand.

This decomposes the prescript into two parts, the arrow-terminals (start: and stop: >), and the arrow line—connecting its terminals (or facets/boundaries) and symbolizing the laws or rules of production.

The terminal receive character-chains, which now not only have the attribute of a length but also physical qualities (like eg. an electrical potential, a geometric form or elasticity of a building block (eg molecule), which is represented as a text)

The production evaluates (i.e. measures) the physical qualities at the terminal, and is realized if a rule or law of production is met (i.e. a linkage between laws and the system dynamics). Two potential existing at the different terminals are translated into a flux where the context between the physical character-sequence attributes “potential” and “flux” is a (f.e. physical) law (fe. U=R·I).

These production can have more terminals and thus more laws, which can be cross-linked among each other by logic operators. Ohms law may be valid, where by at the same action of the production “entropy” must be reduced (flow off at the stop terminal).

Such conditions restrict the way and the order of construction steps, which may produce (nano-) structures, because only particular building-blocks (molecules) with particular qualities can interact at a certain time and volume (boundaries/facets) in a space region (in the network).

A realization of such a mechanism of enhanced productions can be a cell(ular automaton), which compares parameter values at the boundaries of available variables and character-sequences, and links these by predefined rules of production, which reflect laws.

The application of the procedure in conformity with the disclosed invention shows opposite the state of the art especially the following advantages which include but is not limited to fact that:
The text-form is a compact form of representation of system structures (framework, skeleton or topology), and can be altered by means of text-processing end text-editing.
In the text-form transfer, development, generation and reproduction is simpler than using image-processing systems (especially with electronic media when developing large system with many components being combinatorially assembled is very time consuming)
The comparison in text-form represented systems makes an image-recognition or system-recognition possible.
Besides the structure of the system it is also possible to encode characteristics of the construction (development and functionality) of the system cross-linkage in text-form.
In the grammatical text representation the enhancement, optimization and manipulation of the system structure is realizable.
The grammatical text representation permits to adapt the structure of the system to conditions, which follow from the function.
Computer-algorithms can be given, which reconstruct the text-form into the image-like resp. geometric structure and vive versa.
The text-form facilitates the control of automata (computer, roboter), which construct (develop) systems.
The text-form permits to build self-organizing (also self-repairing) systems, which comply with predefined conditions (that includes among other things also to respond to the environment).

The further specification of the inventions taken as a basis for the disclosed procedure follows in reference to three principal examples by means of the figures (see FIG. 1 to FIG. 9).

### FIGURE LEGEND

FIG. 1 shows an electronic circuit wiring diagram of an arrangement of resistors of the Wheatston Bridge, with resistors R1,R2, R3, RA, RX and exterior voltage source U.

FIG. 2 shows a directed graph of the network of FIG. 1 with entry (start) “IN” and exit (stop) “OUT”

FIG. 3 shows a transducer resp. directed graph of the network in FIG. 1, where the resistor are being assigned with values by a language transducer.

FIG. 4 shows a wiring diagram that is assigns to a variable VX

FIG. 5 shows a wiring diagram that is assigned to the variable VX analogical to the FIG. 4

FIG. 6 shows the order of events of a self-organization resp. development of a cross-linkage of six objects (cells) Z1 to Z6 in five steps, by adding one object at the time, f.e.: as biological cells; than it is a self-organization of a six-cell organism with cell-division (cleavage).

FIG. 7 shows the development of the cross-linkage of the objects from FIG. 6 in five steps, represented by directed graphs (left) and the equivalent text-form (right) of the graph, both representations are transformable into one another (f.e. by computer algorithms)

FIG. 8 shows the representation of the development of the cross-linkage of FIG. 7 as grammar of a language in bracket notation (productions); <Vⱼ> are language variables and the letters a, d, . . . , l are elements of the alphabet {a, d, . . . , l}; the equations represent an “equation system” for a text; as solution of the equation system arises the text of step five (finale step of the cross-linkage development) of FIG. 7; the order of solving steps of the equation system (f.e. by successive elimination of variables) provides a way or a plan for the construction of the cross-linked object (system).

FIG. 9 shows an example of coding a tiling. The image part A is given as language graph in image part B.

### EXAMPLE I

The procedures principle is elucidated based on the simple example like the arrangement (the so-called “Wheatstone Bridge”) for determination of resistors.

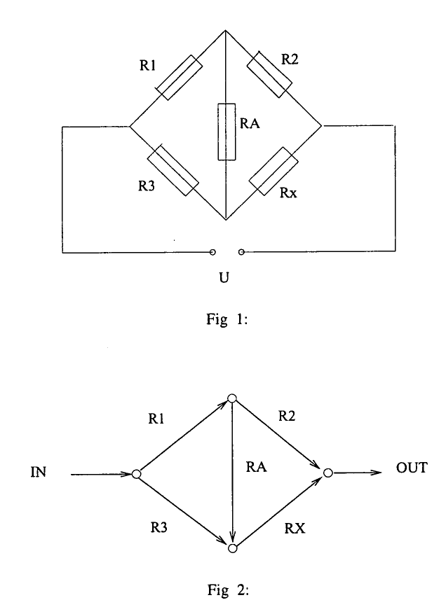

In FIG. 1 are: R1=1.2Ω, R2=3.2Ω, R3=1.5Ω, RA=8Ω resistors of known value. RX is a resistor of a jet unknown value to be measured. At the exterior poles a voltage U is provided, and over the resistor RA the electric voltage A is measured. The task is now to choose RX such that the voltage A becomes zero (vanishes). To determine the value of RX, an adjustable resistor RX, with a calibrated scale is used, that shows the value of R2 in equalized state.

In conformity with the invention now the wiring diagram structure is encoded with words of a language. If the component-symbols (Icons) in FIG. 1 are left out, a graph with the linkage structure of FIG. 2 arises.

If the graph of FIG. 2 is treated as a network of tracks (paths), it is possible to enter the network left at “IN” and leave it on the right side at “OUT”. By following the arrows it is possible to get along the paths (R1-R2 order R1-RA-RX order R3-RX) from “IN” to “OUT”. But these three words are sufficient to describe the structure of linkage of the network i.e. the graph in FIG. 1 and the three words render equivalently the linkage of the network.

The linkage in FIG. 2 can therefore be described with words of a language of the alphabet with the components (here R1,R2,R3,RA,RX).

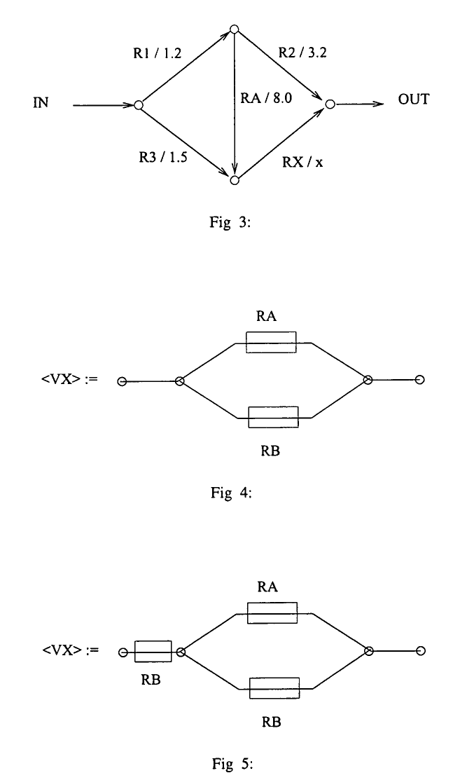

The function of the wiring diagram arises from the dynamic. A realization of the wiring diagram (FIG. 1) is obtained, by substituting the real resistors, i.e. if the letters of the alphabet are replaced by numbers (resistor values). For example R1, R2, R3, RA, RX are being substituted by 1.2, 3.2, 1.5, 8.0, R as shown in FIG. 3.

In the graph of FIG. 3 is the number-assignment from FIG. 1 represented, by adding a number value to each resistor.

In this way the topological structure of FIG. 2 is translated into a real wiring diagram. In the theory of formal languages the translator is an automaton with output (also called “Transducer” after “More” [HD94]).

Is a voltage supplied to the exterior poles of the realized wiring diagram, an electric current flows through each resistor which produces a voltage drop over each resistor. Voltage and current obey the well known laws of physics which cause or give rise to the functional dynamics in the network.

The wiring diagram of the natural system of FIG. 3 is representable as a geometric graph, in which instead of resistor values, distances (metric arrow lengths) are inserted into the transducer. Also the components (resistors in FIG. 1) may be provided by a transducer in the same manner as geometric circuit-symbol-assignments. Equally, the circuit diagram can be modified in the text-representation. There, different assignments of numbers to letter-symbols of the alphabet can take place. Letter-symbols at arrows as numbers can therefore be f.e. the arrow length of the assigned arrow-symbol in the graph.

Now an optimization and adaptation of the system to physical conditions is elucidated. The resistor RX is jet undetermined. It has to be determines such, that the absolute value of the voltage A at the resistor RA is minimal. Given a constant environment (ie. voltage U), the resistors with values taken from the set of resistors {1.2, 3.2, 1.5, 8} may replace RX. A minimal value of the intern voltage A is found for RX=2.3Ω which means the above condition is optimized.

The text-form-representation in conformity with the disclosed invention, enables the introduction of variables for words of word-fragments. If a variable VX introduced for the word RX, VX can represent a subnetwork as shown in FIG. 4.

The three words of the “wiring diagram structure coding” are to be read in variable-representation as: R1R2, R1RA <VX>, R3 <VX> und <VX>, where <VX>=RA or RB is, so that such a network is represented by the five words R1R2, R1RARA, R3RA, R1RARB, R3RB (see FIG. 4).

At the network of FIG. 5, the variable VX is representable with the words:=RBRA or RBRB. The total structure is reproduced by the five words: R1R2, R1RARBRA, R1RARBRB, R3RBRA, R3RBRB.

The introduction of such sub-structures allows to optimize for a given condition like f.e. to minimize the voltage A with a given stock of components (i.e. optimizing by adapting the structure of the system).

The variables of languages provide therefore the possibility to develop sub-structures, which are subject to certain conditions. Especially, it is possible to give and/or specify the way (i.e. the order of events), in which an optimized system-structure is developed resp. is reached, or is constructed, which corresponds to a self-organizing (self-optimizing) system.

### EXAMPLE 2

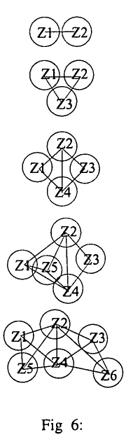

Procedure for the construction of a geometric object. This example regards a procedure in shape of generating a space-configuration of (abstract) building blocks (or here biological cells) at a multi-cellular (f.e. six-cellular biological (see FIG. 6)) organism, where its building-blocks (cells) are donated by Z1 . . . Z6. These cells originate one after another out of the cell Z1 resp. are added to the arising shape, so that f.e. the following order of organization events results: (see FIG. 6)

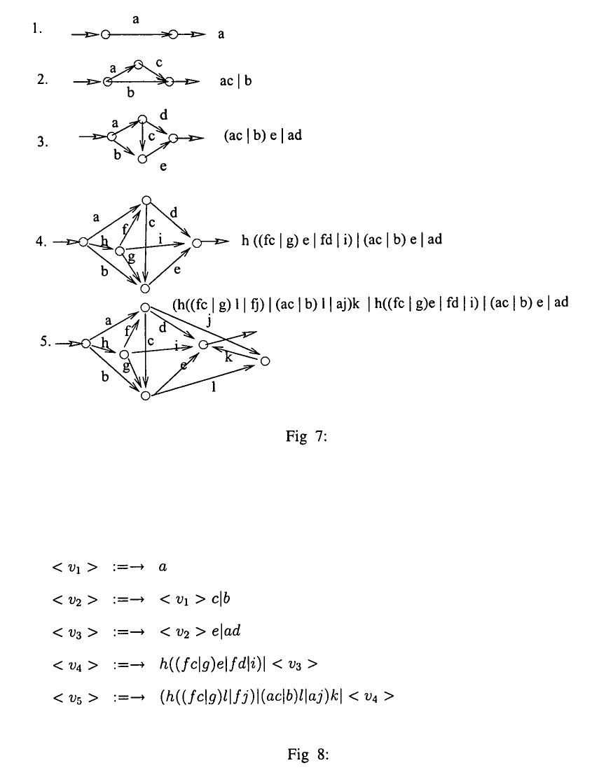

The structure in the fifth development state is the cross-linkage of the final state to be developed (in a sense the Organism). The sequence of the abstract structure of contacts between the building blocks (cells) results as topological network of a graph-sequence as follows: (see FIG. 7)

As starting point of a new structure is chosen each time the state “IN” (cell Z1). The end state “OUT” in the path-network is the building-block (cell Z3 resp. initial Z2) determined.

Is the alphabet {Z1, Z2, . . . , Z6} given, the single graphs form FIG. 7 are to be represented as words of a grammar as follows.

The topological network to be generated in the end (step five in FIG. 6) can be constructed, by verifying all intermediate-structure-steps (networks) against the end-structure.

The topological end-structure represents in a sense the framework, around which the geometric object (here the cell-aggregate) is being constructed.

Numbers can be assigned to the letters in FIG. 7, as in Example 1 for the case of switching elements. If the numbers represent distances between the space-points Z1 . . . Z6, than from the network graph of FIG. 7 a space-framework arises (i.e. a geometric object). Are cell-contacts the issue (as in FIG. 6), so arises therefrom a cell-aggregate (resp. an organism).

The order of events of the development of the cross-linkage from FIG. 7 can be given as the grammar for the text-representation. The associate grammar is shown in FIG. 8.

The grammar is an equation system for a word (resp. words) of the language, which is determined by the grammar. The solution of the equation system from FIG. 8 reveals as result the word (i.e. the text of step five in FIG. 7), which represents the end-structure. The order of solving steps of the equation system is at the same time an instruction to develop the end-structure (step five in FIG. 7) (i.e. to construct). In the example, the order of solving steps is the development represented in the steps 1 to 5 of FIG. 7.

In FIG. 7 all arrows of a graph are provided with different letters. Alternatively, letters can be used simultaneously. As long as the so reduced number of letters (elements of the alphabet of the language) dose not fall below the maximal number of arrows leaving a knot (state, vertex) of the graph, it is always possible to a give a unique path (for a word) between the knots (states, vertices). Otherwise it is necessary to test several paths in addition to the ambiguity to determine whether the word is accepted or not.

Those in the proceeding elucidated examples 1 and 2 represented applications are based on graphs, where words with one entry and one exit of the graph are reproduced. Representations using words with more entries and exits resp. cross-linked switching of entries and exits of graphs, enhance the simple examples. This way the construction may be carried out in parts resp. can begin at different staring-points (“IN”).

The representation as a grammar (see FIG. 8) can be more compact as the solving-text (see. FIG. 7). Especially, the grammar is an alternative text-form, if a system as that in FIG. 8 is under-determined, i.e. if language variables can still be freely predefined (or given).

Beyond that, more solutions of the grammar exist (in context sensitive grammars), whose solving-text is uniquely determined only after conditions in the systems environment (i.e. the context) is specified.

### EXAMPLE 3

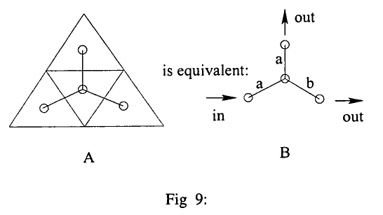

The example regards the coding of a (tiling-)patterns. The neighbor-relations between objects (e.g. tiling) can be given in text-form corresponding to the examples 1 and 2, which can be represented in a symmetric matrix. If the object are triangles, than the structure can be coded by the language graph B in FIG. 9, which has one start-point (start-state “IN”) and two end-points (end-states “OUT”). Universal, this way (tessellation) patterns can be represented. If the distances of the tiling (A in FIG. 9: Triangle-intersection) is given by a symmetric distance-matrix (transducer), consequently the geometric configuration is specified.

### LITERATURE

[AU77] A. Aho and J. D. Ullman. Principles of compiler design. Addison Wesley, 1977.
[Ber79] J. Berstel. Transductions and Context-Free Languages. B. G. Teubner, Stuttgart, 1979.
[CD91a] F. M. Callier and CA. Desoer. Linear System Theory. Springer Verlag, 1991.
[CD91b] Frank M. Callier and Charles A. Desoer. Linear System Theory. Springer Verlag, 1991.
[ET75] Hartmut Ehrig and Karl Wilhelm Tischer. Graph grammars and application to specialization and evolution in biology. Journal of Computer and System Science, 11:212-236, 1975.
[GD90] A. Goldbeter and G. Dupont. Allosteric regulation, cooperativity, and biochemical oscillations. Biophysical Chemistry, 37:341-353, 1990.
[GDLM88] A. Goldbeter, O. Decroly, Y. X. Li, and F Moran. Finding complex oscillatory phenomena in biochemical systems; an empirical approach. Biophysical Chemistry, 29:211-217, 1988.
[GL72] A. Goldbeter and R. Lefever. Dissipative structures for an allosteric model. application to glycolytic oscillations. Biophysical Journal, 12:1302-1315, 1972.
[HD94] Jhon E. Hopcroft and Ullman Jeffrey D. Einführung in die Automatentheorie, formale Sprachen und Komplexitätstheorie. Addison Wesley, 1994.
[Kr [symbol] 99] A. Kr [symbol] mer. Struktur und dynamik eines komplexen systems charakterisiert mittels der multiresolution-technik der signalanalyse am beispiel von relaxations-oszillationen. Master's thesis, Biochemisches Institut Im Fachbereich Medizin der Universitaet zu Kiel, January 1999. Diplom in Physik.
[MMTV] O. Matz, A. Miller, A. and Potthoff, W. Thomas, and E. Valkema, October.
[OD71] G. F. Oster and C. A. Desoer. Tellegen's theorem and thermodynamic inequalities. Journal of Theoretical Biology, 32:219-241, 1971.
[Ons31] L. Onsager. Reciprocal relation in irreversible process. Phys. Rev., 32:405-426, 1931.
[OPK71] G. Oster, A. Perelson, and A. Katchalsky. Network thermodynamics. Nature, 234, 1971.
[Pea93] J. E. Pearson. Complex patterns in a simple system. Science, 261:189-92, 9. July 1993.
[Pri47] Ily Prigogine. Etude Thermodynamiqe des Processus Irreversibeles. Liege, 1947.
[SML98] W Schroeder, K. Martin, and B. Lorensen. The visualization toolkit vtk. Number ISBN: 0-13-954694-4. Prentice Hall PTR, 1998.
[Wil96] J. R. Wilson. Linear system theory. Prentice Hall, Upper Saddle River, N.J., 1996.
[Xie00] Changsong Xie. Syntax-oriented Coding A Data Compression Scheme for Syntactically Structured Sources. PhD thesis, UNVERSITAT DER BUNDES-WEHR MUNCHEN Fakultat fur Elektrotechnike, 2000.

1. Procedure for the construction of a cross-linkage of a system, whose topology of components stretch a network, comprising:
a. the network is represented as a graph;
b. edges of the graph are provided with markings, which are formed such, that the graph can be unambiguously assigned to a (minimal) automaton;
c. the automaton is described by a formal language grammar representing a system of equations whose solution are defined in text form, wherein the approach to obtain the solutions of the system of equations describes a way to construct the system while transducers insert the components into the network in order to entirely construct the system.

2. The closure of claim 1, wherein said system is a natural realized thermodynamic system.

3. The closure of claim 2, wherein said system is a chemical reaction system.

4. The closure of claim 2, wherein said system is a mechanical system.

5. The closure of claim 2, wherein said system is an electrical system.

6. The closure of claim 1, wherein said system comprises nano-technological and/or biological sub-systems, which are cross-linked by communication processes and/or by affiliation and/or by assignment.

7. The closure of claim 1 to 6, wherein said system represents the order of events of an organization (f.e. an economic development) process in a (f.e. economic) system.

8. The closure of claim 7, wherein said order of organizational processing events comprises the development of a (f.e. economic) system.

9. The closure of claim 7 to 8, wherein said organization process comprises a self-organizing system.

10. The closure of claim 1 to 9, wherein said systems is constructed using language-elements of a formal language described by minimal automaton where said language elements are supposed to be used for construction, reconstruction, decomposition and editing of compound structures comprised of sub-systems of arbitrary nature.

11. The closure of claim 1 to 9, wherein said language elements of a language describes by a minimal automata are supposed to be used for automatically constructing a logical or physical network of computer processors, which can work on parallel tasks.

12. (canceled)

13. The closure of claim 11, wherein said processors are designed to develop specific and/or compound functionality.

14. The closure of claim 10 to 13, wherein said language elements are used for transmitting images of network-structures in text-form.

15. The closure of claim 10 to 14, wherein said language elements are used for construction and/or processing and/or transmitting of surfaces (nano-structures) structures of materials for the purpose of surface coating and/or treatment in a image and/or a network structure equivalent text-form representation.

16. The closure of claim 13 to 15, wherein said language elements are used create and/or process and/or transmitting compound-structures in text-form, which are surfaces of biological systems.

17. The closure of claim 1 to 16, wherein said language elements are used to compare said system with a different system by means of the text-form of a language of a minimal automaton.

18. The closure of claim 1 to 10, wherein said system being constructed is a geometric structure (framework, construction drawing).

19. The closure of claim 1 to 10, wherein said system being constructed comprises a (economic) production process and/or a supply chain.

20. The closure of claim 1 to 10, wherein said language elements are used to cross-link components of physical or of logical nature.

21. The closure of claim 1 to 20, wherein said language elements are used for construction, reconstruction, compression, decomposition, editing, recognition and transmitting of speech.
